(19) United States
(12) Patent Application Publication
(10) Pub. No.: US 2008/0032189 A1
(43) Pub. Date: Feb. 7, 2008

(54) Modular fuel delivery subsystem for an electrochemical cell-based system

(76) Inventors: Richard H. Cutright, Corinth, NY (US); Adam K. Brunner, Castleton, NY (US)

Correspondence Address: TROP PRUNER & HU, PC, 1616 S. VOSS ROAD, SUITE 750, HOUSTON, TX, 77057-2631, US

(21) Appl. No.: 11/788,783

(22) Filed: Apr. 20, 2007

Related U.S. Application Data
(60) Provisional application No. 60/793,763, filed on Apr. 21, 2006.

(51) Int. Cl. H01M 2/00

(52) U.S. Cl. 429/163; 29/623.1

(57) ABSTRACT

An apparatus includes a housing, a pullout drawer and at least one purification bed container. The housing is adapted to house at least one electrochemical cell, and the purification bed container(s) are mounted to the pullout drawer.

This application claims the benefit under 35 U.S.C. § 119(e) to U.S. Provisional Application Ser. No. 60/793,763, entitled “MODULAR FUEL BLOWER AND DESULFURIZATION DESIGN,” which was filed on Apr. 21, 2006, and is hereby incorporated by reference in its entirety.

### BACKGROUND

The invention generally relates to a modular fuel delivery subsystem for an electrochemical cell-based system.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange member (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
H₂→2H⁺2e⁻ at the anode of the cell, and Equation 1
O₂+4H⁺+4e⁻→2H₂O at the cathode of the cell Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, an apparatus includes a housing, a pullout drawer and at least one purification bed container. The housing is adapted to house at least one electrochemical cell, and the purification bed container(s) are mounted to the pullout drawer.

In another embodiment of the invention, an apparatus includes a housing, a pullout drawer and a fuel blower. The housing is adapted to house at least one electrochemical cell, and the fuel blower is mounted to the pullout drawer.

Advantages and other features of the invention will become apparent from the following drawing, description and claims.

### BRIEF DESCRIPTION OF THE DRAWING

FIG. 1 is a perspective view of a fuel cell system according to an embodiment of the invention.

FIG. 2 is a perspective view of a modular delivery subsystem of the fuel cell system of FIG. 1 according to an embodiment of the invention.

FIG. 3 is a schematic diagram of the fuel cell system according to an embodiment of the invention.

### DETAILED DESCRIPTION

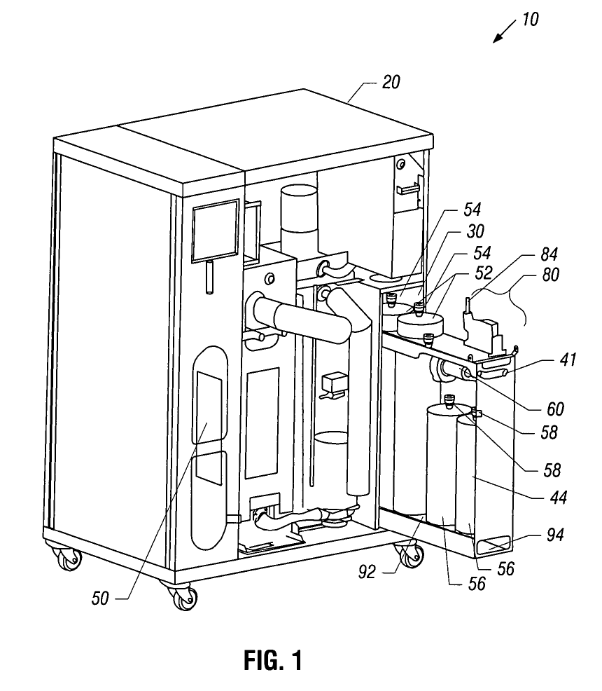

Referring to FIG. 1, in accordance with some embodiments of the invention, a fuel cell system 10 is housed inside a cabinet 20 (shown with its front panel removed in FIG. 1), which serves as a housing for the system 10. Among its various components, the fuel cell system 10 includes a fuel cell stack 50 and a modular fuel delivery subsystem 39, which is mounted on a pullout drawer 40 that is slidably mounted with respect to the cabinet 20. In this regard, the pullout drawer 40 is mounted on drawer guides (not depicted), which allow the drawer 40 to be extended (as depicted in FIG. 1) and retracted with respect to the other fuel cell system components that are mounted to the cabinet 20. More specifically, the drawer 40 may be extended from the cabinet 20 by grasping a knockout handle opening 94 that is formed in the drawer 40, in accordance with some embodiments of the invention.

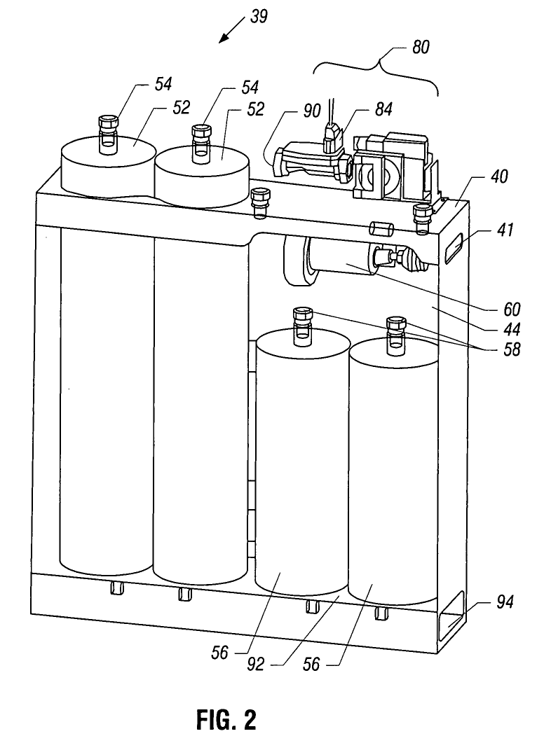

Referring to both FIGS. 1 and 2, as described herein, the fuel delivery subsystem 39 is packaged in a way, which maximizes the serviceability of its desulfurization canisters, or cans 52 and 56, and minimizes occupied space, cost and manufacturing time. More specifically, in accordance with embodiments of the invention described herein, the desulfurization cans 52 and 56 are closely packaged together with a fuel blower 60 and flow monitoring equipment 80 (all part of the fuel delivery subsystem 39) on the pullout drawer 40, which permits accessibility to the subsystem after undoing only two mechanical connections: the natural gas inlet (which connects to an inlet 54 of one of the cans 52, for example) to the fuel delivery subsystem 39 and a wire harness 84.

In accordance with some embodiments of the invention, the desulfurization cans 52 and 56 are associated with two desulfurization beds, such as Siliporite and Selexorb. For purposes of reducing the height of each purification module, two cans are provided for each of the absorption beds. For example, in accordance with some embodiments of the invention, the cans 52 may form a Siliporite purification bed, and the cans 56 may form a Selexorb bed.

The cans 52 and 56 are serially connected, or plumbed, together. More specifically, the natural gas inlet to the fuel cell subsystem may be connected to a top connector 54 of one of the cans 52 so that natural gas flows from the top of the can 52 to its bottom. Plumbing (not shown) that is contained beneath a floor 92 of the pullout drawer 40 connects a bottom connection of the can 52 to the bottom connection of the other can 52. Thus, natural gas flows through this other can from bottom to top to its top connection 54. The top connection 54 of this can 52 may then be connected to the top connection 58 of one of the cans 56. Similarly, the cans 56 are connected together at their bottom ends via plumbing that is present in the space 94 beneath the floor 92.

From the last can 56 in the serial connection, the natural gas flows to the fuel blower 60. In this regard, the suction inlet of the fuel blower 60 may connected to the top outlet 58 of the last can 56 in the series so that the fuel blower 60 produces a flow that exits an exhaust port 90 of the fuel subsystem. As depicted best in FIG. 2, flow monitoring equipment 80 may be connected to the outlet of the fuel blower 60 for such purposes as monitoring the flow rate and pressure of the outgoing fuel flow. As specific examples, in accordance with some embodiments of the invention, the equipment 80 may include a pressure sensor and/or a flow metering device. Electrical cables that are used for such purposes as controlling, powering and receiving feedback from the equipment 80 and fuel blower 60 are connected via the wire harness 84.

Due to the compact design of the fuel delivery subsystem 39, all fuel delivery parts may be easily pre-assembled, tested and leak-checked by a vendor and installed by manufacturing by simply sliding the pullout drawer 40 into place; and making the inlet and outlet natural gas connections; and connecting the wire harness 84.

Many variations are possible and are within the scope of the appended claims. For example, in accordance with some embodiments of the invention, fewer or more desulfurization cans 52 and 58 may be provided in accordance with other embodiments of the invention. For example, if the system footprint instead of the height were more important, the four desulfurization cans 52 and 56 may be replaced with two taller desulfurization cans (one to establish the Siliporite bed and the other to establish the Selexorb bed, for example).

The advantages of the above-described modular fuel delivery subsystem 39 may include one or more of the following: 1.) the subsystem results in a true “module,” containing all fuel delivery parts; 2.) the subsystem may be pre-assembled, tested and leak checked by a vendor resulting in lower cost and higher reliability; 3.) in-house manufacturing may install the subsystem by simply setting it in place, connecting inlet, outlet and wire harness reducing manufacturing cost and increasing reliability; and 4.) the desulfurization cans system may be serviced by pulling out the drawer 40 from the cabinet 20 and changing the cans, thereby saving service time. Other and different advantages are possible, depending on the particular embodiment of the invention.

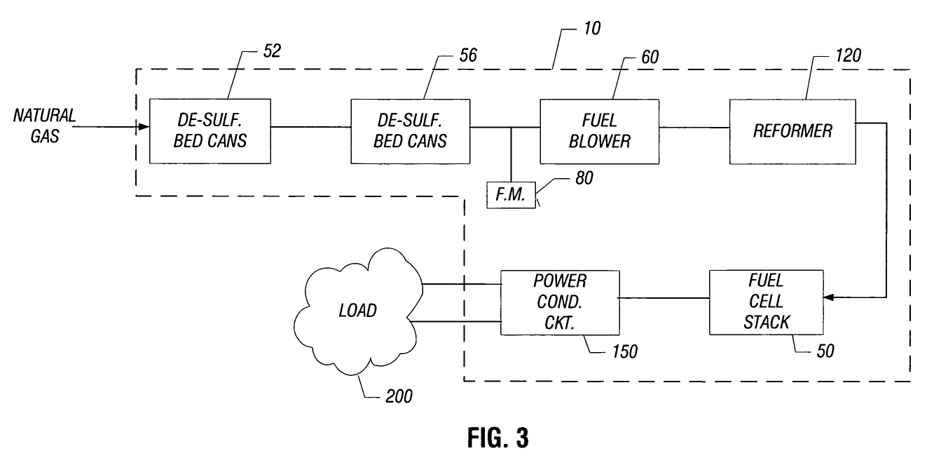

FIG. 3 generally depicts a schematic diagram of the fuel cell system 10 in accordance with some embodiments of the invention. Natural gas flows through the desulfurization bed cans 52 and 56 and to the suction inlet of the fuel blower 60. The fuel monitoring equipment 80 monitors the flow out of the desulfurization bed cans 56 and may be connected to a system controller (not depicted in FIG. 3) of the fuel cell system 10 for purposes of monitoring the flow and controlling the reformer 120 and/or fuel blower 60 accordingly, in accordance with the various possible embodiments of the invention.

The outlet of the fuel blower 60 furnishes a fuel flow to a reformer 120, which produces a reformate flow to the fuel cell stack 50. Among its other features, the fuel cell system 10 may include power conditioning circuitry 110 that converts the electrical output from the fuel cell stack 50 into the appropriate form for a load 200 to the fuel cell system 10. For example, in embodiments of the invention in which the fuel cell system 10 provides power to a DC load, the power conditioning circuitry 150 transforms the DC stack voltage from the fuel cell stack 50 into the appropriate DC level for the DC load. Alternatively, in embodiments of the invention in which the load 200 is an AC load, the power conditioning circuitry 150 transforms the DC stack output from the fuel cell stack 50 into the appropriate AC voltage for the AC load. Additionally, it is noted that other variations are possible and are within the scope of the appended claims. For example, in other embodiments of the invention, the fuel cell system 10 may supply heat and not electrical power for a particular application. As another example, in another embodiment of the invention, the fuel cell system 10 may supply both electrical power and heat for a particular application.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An apparatus comprising:
a housing for an electrochemical cell system, the housing adapted to house at least one electrochemical cell;
a pullout drawer; and
at least one purification bed container mounted to the pullout drawer.

2. The apparatus of claim 1, further comprising:
a fuel blower mounted to the pullout drawer.

3. The apparatus of claim 1, further comprising:
a flow monitoring sensor mounted to the pullout drawer.

4. The apparatus of claim 3, wherein the flow monitoring sensor comprises at least one of a flow meter and a pressure sensor.

5. The apparatus of claim 1, wherein said at least one purification bed container comprises at least two containers associated with different purification bed materials.

6. The apparatus of claim 1, wherein said at least one purification bed container comprises at least two containers connected in series.

7. The apparatus of claim 1, further comprising:
a electrochemical cell stack mounted inside the housing and not being connected to the pullout drawer.

8. An apparatus comprising:
a housing for an electrochemical cell system, the housing adapted to house at least one electrochemical cell;
a pullout drawer; and
at least one fuel blower being mounted to the pullout drawer.

9. The apparatus of claim 8, further comprising:
a electrochemical cell stack mounted inside the housing and not being connected to the pullout drawer.

10. A method comprising:
mounting at least one purification bed container mounted to a pullout drawer; and
installing the pullout drawer in a housing that contains at least one electrochemical cell.

11. The method of claim 10, further comprising:
mounting a fuel blower to the pullout drawer.

12. The method of claim 11, further comprising:
mounting a flow monitoring sensor to the pullout drawer.

13. The method of claim 12, wherein the flow monitoring sensor comprises at least one of a flow meter and a pressure sensor.

14. The method of claim 10, wherein the mounting comprises mounting at least two containers associated with different purification bed materials to the pullout drawer.

15. The method of claim 10, further comprising:
serially connecting at least two of said at least one purification bed container together.
